(19) United States
(12) Patent Application Publication
(10) Pub. No.: US 2021/0150923 A1
(43) Pub. Date: May 20, 2021

(54) ELECTRONIC DEVICE AND METHOD FOR ESTIMATING THE POSITION(S) OF AIR TRAFFIC ELEMENT(S), RELATED DISPLAY SYSTEM AND COMPUTER PROGRAM

(71) Applicant: THALES, Courbevoie (FR)

(72) Inventors: Thomas RIPOCHE, Merignac (FR); Thierry Ganille, Merignac (FR); Pierre-Yves Dumas, Merignac (FR)

(21) Appl. No.: 16/952,975

(22) Filed: Nov. 19, 2020

(30) Foreign Application Priority Data
Nov. 20, 2019 (FR) 19 12938

(51) Int. Cl. G08G 5/04; G08G 5/00

(52) U.S. Cl. CPC G08G 5/045; G08G 5/0021

(57) ABSTRACT

Electronic device for estimating a position of an air traffic element intended to be carried on board an aircraft, and comprising a module for acquiring a measured position of the air traffic element and complementary measured navigation information of the air traffic element; and a module for calculating an estimated position of the air traffic element.

The calculation module is configured to calculate the estimated position of the air traffic element as a function of the measured position and of the complementary measured navigation information acquired for the air traffic element.

The complementary measured navigation information is preferably a measured position of the complementary air traffic element, or a set of at least two measured positions of the complementary air traffic element, or even a measured speed of the air traffic element.

### CROSS-REFERENCE TO RELATED APPLICATIONS

This application is a U.S. non-provisional application claiming the benefit of French Application No. 19 12938, filed on Nov. 20, 2019, which is incorporated herein by reference in its entirety.

### FIELD

The present invention relates to an electronic device for estimating a position of an air traffic element, the device being intended to be carried on board an aircraft.

The invention also relates to an air traffic element display system, intended to be carried on board an aircraft, and comprising a display screen, a display module linked to the display screen and such an electronic estimation device connected to the display module.

The invention also relates to a method for estimating the position of an air traffic element, the method being implemented by such an electronic estimation device intended to be carried on board an aircraft.

The invention also relates to a non-transitory computer-readable medium including a computer program comprising software instructions which, when executed by a computer, implement such an estimation method.

### BACKGROUND

The invention relates to the field of display systems for air traffic element(s), preferably intended to be carried on board an aircraft.

The invention relates, in particular, to the field of devices for estimating the position of traffic elements included in these display systems.

An estimation device of the aforementioned type is known, comprising a module for acquiring a measured position of an air traffic element and a module for calculating an estimated position of the air traffic element.

The calculation module of such a device is generally able to calculate an estimated position of the air traffic element based on the last acquired measured position of the air traffic element. An estimated position is then calculated following each acquisition of a measured position.

With the development of navigation systems that accurately measure the position, speed and heading of air traffic elements, in particular using the ADS-B system, standing for Automatic Dependent Surveillance-Broadcast, it is possible to consider a compliant display of estimated positions in an aircraft cockpit, i.e. a display on a so-called head-up transparent screen where the estimated positions are superimposed on a real landscape surrounding a user.

However, the aforementioned estimation device allows the updating of estimated positions only following a new acquisition of a measured position, wherein the evolution of the estimated position is therefore discontinuous. Thus, between each acquisition, the estimated position is frozen, and is inconsistent with the actual position of the air traffic element.

### SUMMARY

The aim of this invention is, therefore, to provide an estimation device in which the evolution of the estimated position appears more continuously, and in which the inconsistencies between the real position of the air traffic element and its estimated position are minimized.

To this end, the object of the invention is an electronic device for estimating a position of an air traffic element, the device being intended to be carried on board an aircraft and comprising:
an acquisition module configured to acquire a measured position of the air traffic element and complementary measured navigation information of the air traffic element; and
a calculation module configured to calculate an estimated position of the air traffic element, the estimated position of the air traffic element being calculated as a function of the measured position and of the complementary measured navigation information acquired for the air traffic element,

the complementary measured navigation information for the air traffic element being preferably chosen from among the group consisting of: a measured position of the complementary air traffic element, a set of at least two measured positions of the complementary air traffic element, and a measured speed of the air traffic element.

According to other advantageous aspects of the invention, the estimation device comprises one or more of the following characteristics, taken in isolation or in any technically feasible combination:
the calculation module is configured to calculate the estimated position of the air traffic element by extrapolation from the measured position and the complementary measured navigation information of the air traffic element,
the extrapolation preferably being a linear or polynomial extrapolation;
the device further comprises an evaluation module configured to evaluate a confidence index for the estimated position of the air traffic element,

the calculation of the confidence index preferably being a function of a time elapsed between a temporal instant of acquisition of the measured position and of the complementary measured navigation information, and a temporal instant of calculation of the estimated position;
the device further comprises a generation module configured to generate position data capable of being displayed on a display screen, preferably on a transparent display screen, said data depending on the estimated position of the element of air traffic;
the generation module is configured to generate said position data further based on the confidence index;
the calculation module is configured to calculate the estimated position of the air traffic element as a function of a predefined latency period between the acquisition of the measured position of an air traffic element and the generation of position data corresponding to said measured position; and
the device further comprises a filtering module configured to filter the measured position(s) and the complementary measured navigation information of the air traffic element according to their consistency with respect to a previously measured position and to complementary previously measured navigation information, and to keep only measured positions and additional validated measured navigation information having a level of consistency greater than a predefined threshold, the calculation module then being configured to calculate the estimated position of the traffic air element according to a measured position and complementary validated measured navigation information.

The object of the invention is also an electronic system for displaying the position data of air traffic element(s), intended to be carried on board an aircraft, and comprising a display screen, a display module connected to the display screen, and an electronic device for estimating a position of an air traffic element, the device being connected to the display module and as defined above, the display module being configured to display position data on the display screen.

The object of the invention is also a method for estimating a position of an air traffic element, the method being implemented by an electronic estimation device intended to be carried on board an aircraft and comprising the following steps:
acquisition of a measured position of the air traffic element and of complementary measured navigation information of the air traffic element; and
calculation of an estimated position of the respective air traffic element, the estimated position of the air traffic element being calculated as a function of the measured position and the complementary measured navigation information acquired for the air traffic element,

the complementary measured navigation information for the air traffic element being preferably chosen from among the group consisting of: a measured position of the complementary air traffic element, a set of at least two complementary measured positions of the air traffic element and a measured speed of the air traffic element.

The object of the invention is also a non-transitory computer-readable medium including a computer program comprising software instructions which, when executed by a computer, implement an estimation method as defined above.

### BRIEF DESCRIPTION OF THE DRAWINGS

These characteristics and advantages of the invention will become more apparent upon reading the description which follows, given solely by way of non-limiting example, and made with reference to the accompanying drawings, in which:

FIG. 1 is a schematic representation of an aircraft equipped with an electronic head-up display system for air traffic element position data according to the invention, comprising a display screen, a display module connected to the display screen, and an electronic device for estimating a position of an air traffic element, connected to the display module;

FIG. 2 is a schematic representation of estimated positions, measured positions and complementary measured navigation information of a set of traffic elements;

FIG. 3 is a view of a first example of a compliant head-up display of estimated positions on the display screen;

FIG. 4 is a view of a second exemplary compliant head-up display of estimated positions on the display screen; and

FIG. 5 is a flowchart of the estimation process according to the invention.

### DETAILED DESCRIPTION

In the remainder of the description, the expression “substantially equal to” defines a relationship of equality of plus or minus 10%, preferably plus or minus 5%.

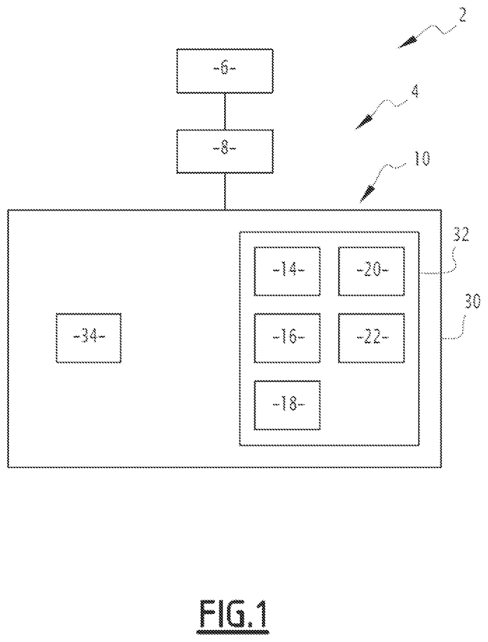

In FIG. 1, an aircraft 2 comprises an electronic system 4 for displaying the position data of air traffic element(s), comprising a display screen 6, a display module 8 and an electronic estimation device 10 for a position Pₑₛₜ of an air traffic element 12. The electronic estimation device 10 is linked to the display module 8, while the display module 8 is linked to the display screen 6.

The aircraft 2 is preferably an airplane. Alternatively, the aircraft 2 may be a helicopter, or even a drone.

The display system 4 is carried on board the aircraft 2. Alternatively, the display system 4 may be installed in an air traffic control center.

The display screen 6 is preferably a transparent display screen. The display screen 6 may be, for example, integrated in a helmet, such as an augmented reality helmet. The display screen 6 then has display surfaces configured to face the eyes of a user, and is a screen of an HWD (Head Worn Display) device. Alternatively, the screen may be fixed on the aircraft 2, and is a screen of a device of the HUD type (Head Up Display). A screen of an HWD device or of a HUD device is configured to allow a compliant display of a symbol representing an air traffic element 12, allowing superposition of the symbol representing the air traffic element and the air traffic element seen through the screen.

Alternatively, the display screen 6 may be a head-down screen also making it possible to display a synthetic vision of the terrain (SVS).

The display module 8 is preferably configured to display on the display screen 6 position data generated by the estimation device 10, as will be described later.

In the example of FIG. 1, the estimation device 10 is carried on board the aircraft 2. Alternatively, the estimation device 10 may be installed in an air traffic control center.

The estimation device 10 comprises a module 14 for acquiring a measured position Pₘₑₛ of the air traffic element 12 and complementary measured navigation information Inavₘₑₛ of the air traffic element 12 and a calculation module 16 for an estimated position Pₑₛₜ of the air traffic element 12.

As an optional addition, the estimation device 10 may comprise a module 18 for filtering the measured position(s) Pₘₑₛ and the complementary measured navigation information Inavₘₑₛ of the air traffic element 12 and/or an evaluation module 20 of a confidence index for the estimated position Pₑₛₜ of the air traffic element 12 and/or a module 22 for generating position data capable of being displayed on the display screen 6.

In the example of FIG. 1, the estimation device 10 comprises an information processing unit 30 formed, for example, by a memory 32 associated with a processor 34.

In the example of FIG. 1, the acquisition module 14 and the calculation module 16, as well as an optional complementary filtering module 18, the evaluation module 20 and the generation module 22, are each produced in the form of software programs that may be executed by the processor 34. The memory 32 is then able to store software for acquiring a measured position Pₘₑₛ and complementary measured navigation information Inavₘₑₛ of the air traffic element 12, a software program for calculating an estimated position Pₑₛₜ of the air traffic element 12, as well as optional software for filtering the measured position(s) Pₘₑₛ and the complementary measured navigation information Inavₘₑₛ of the air traffic element 12, a software program for evaluating a confidence index for the estimated position Pₑₛₜ of the air traffic element 12, and a software program for generating position data capable of being displayed on the screen of the display 6.

In a variant not shown, the acquisition module 14 and the calculation module 16, as well as, as an optional addition, the filtering module 18, the evaluation module 20 and the generation module 22, are each produced in the form of a programmable logic component, such as an FPGA (Field Programmable Gate Array), or in the form of a dedicated integrated circuit, such as an ASIC (Application Specific Integrated Circuit).

When the electronic estimation device 10 is produced in the form of one or more software programs, i.e. in the form of computer programs, it is also able to be recorded on a computer-readable medium (not shown). The computer readable medium is, for example, a medium capable of storing electronic instructions and of being coupled to a bus of a computer system. By way of example, the readable medium may be an optical disc, a magneto-optical disc, a ROM memory, a RAM memory, any type of non-volatile memory (for example, EPROM, EEPROM, FLASH, NVRAM), a magnetic card or an optical card. On the readable medium is then stored a computer program comprising software instructions.

The air traffic element 12 may be, for example, an aircraft, such as an airplane, a helicopter or even a drone.

The acquisition module 14 is configured to acquire a measured position Pₘₑₛ and complementary measured navigation information Inavₘₑₛ of an air traffic element 12. The complementary measured navigation information Inavₘₑₛ is, for example, a complementary measured position Pₘₑₛ, a set at least two complementary measured positions Pₘₑₛ or a measured speed Vₘₑₛ of the air traffic element 12. The measured position Pₘₑₛ and the complementary measured navigation information Inavₘₑₛ are, for example, stored in the aircraft 2, preferably in a storage unit (not shown) of the acquisition module 14. In a particular variant, when the complementary measured navigation information Inavₘₑₛ is a complementary measured position Pₘₑₛ or a set of at least two complementary measured positions Pₘₑₛ, the complementary measured navigation information Inavₘₑₛ corresponds to a previously measured position Pₘₑₛ or to a set of previously measured positions Pₘₑₛ and stored in the storage unit. The measured position Pₘₑₛ and the complementary measured navigation information Inavₘₑₛ of the air traffic element 12 are, for example, sent by an on-board system in the air traffic element 12 before being stored in the storage unit. The measured position Pₘₑₛ and the complementary measured navigation information Inavₘₑₛ are preferably sent by an ADS-B system (Automatic Dependent Surveillance-Broadcast) on board each air traffic element 12 which periodically sends the measured position Pₘₑₛ and/or the complementary measured navigation information Inavₘₑₛ from the air traffic element 12 and broadcast to all the surrounding aircraft within reception range, such as the aircraft 2. Those skilled in the art will understand that a measured position Pₘₑₛ is suitable for being stored in the storage unit, so as to be used subsequently as complementary measured navigation information Inavₘₑₛ.

The radio reception range varies, for example, according to the power and sensitivity of the radio equipment on board by the air traffic elements 12 and the aircraft 2, according to the position of the antennas of the ADS-B system on the traffic elements 12 and on the aircraft 2, depending on the relative position of the traffic elements 12 and of the aircraft 2, and possible obstructions by terrain and/or buildings. The range of such transmissions is typically of the order of several tens of Nm (Nautical mile). The reception range is, for example, 100 Nm to the front and rear and 30 Nm to the sides of the aircraft 2 and of each air traffic element 12. The measured speed Vₘₑₛ corresponds, for example, to a speed vector deduced from ground speed, vertical speed and heading information measured by the air traffic element 12, and preferably sent to the aircraft 2 by an ADS-B system.

The calculation module 16 is configured to calculate an estimated position Pₑₛₜ of the air traffic element 12. The calculation module 16 is configured to calculate the estimated position Pₑₛₜ of the air traffic element 12 as a function of the measured position Pₑₛₜ and complementary measured navigation information Inavₘₑₛ of the air traffic element 12.

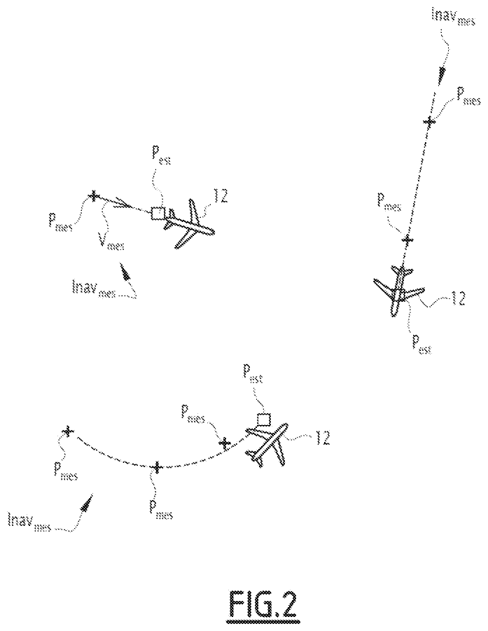

The calculation module 16 is preferably configured to calculate the estimated position Pₑₛₜ of the air traffic element 12 as a function of a measured position Pₘₑₛ and of complementary measured navigation information Inavₘₑₛ validated by the filtering module 18, wherein this will be described in more detail below. In the remainder of the description, the measured position Pₑₛₜ and the complementary measured navigation information Inavₘₑₛ are positions and information validated by the filtering module 18. FIG. 2 illustrates, by way of example, an estimated position Pₑₛₜ calculated as a function of a measured position Pₘₑₛ and complementary measured navigation information Inavₘₑₛ corresponding to a measured speed Vₘₑₛ of the air traffic element 12 (top left of FIG. 2), an estimated position Pₑₛₜ is calculated as a function of a measured position Pₘₑₛ and complementary measured navigation information Inavₘₑₛ corresponding to a measured complementary position Pₘₑₛ (top right of FIG. 2), and an estimated position Pₑₛₜ is calculated as a function of a measured position Pₘₑₛ and complementary measured navigation information Inavₘₑₛ corresponding to two complementary measured positions Pₘₑₛ (at the bottom of FIG. 2). In FIG. 2, the estimated positions Pₑₛₜ are represented by rectangles, the measured positions Pₘₑₛ used for the estimation are represented by crosses, and the measured speed Vₘₑₛ is represented by an arrow.

Those skilled in the art will thus understand that the complementary measured navigation information Inavₘₑₛ corresponds to any information used in addition to the measured position Pₘₑₛ in order to calculate the estimated position Pₑₛₜ. In particular, the complementary measured navigation information Inavₘₑₛ corresponds, according to a first variant, to data transmitted by an ADS-B system to the acquisition module 14 at the same time as the measured position Pₘₑₛ, the complementary measured navigation information Inavₘₑₛ being, for example, a measured speed Vₘₑₛ of the air traffic element 12. According to a second variant, the complementary measured navigation information Inavₘₑₛ corresponds to data transmitted by an ADS-B system to the acquisition module 14 prior to the measured position Pₘₑₛ, the complementary measured navigation information Inavₘₑₛ being, for example, a complementary measured position Pₘₑₛ or a set of at least two complementary measured positions Pₘₑₛ, the complementary measured positions Pₘₑₛ being previously measured positions and, for example, stored in the storage unit of the acquisition module.

The calculation module 16 is preferably configured to calculate the estimated position Pₑₛₜ of the air traffic element 12 by an extrapolation from the measured position Pₘₑₛ of the air traffic element 12 and the complementary measured navigation information Inavₘₑₛ of the air traffic element 12. The calculation module 16 is, for example, configured to calculate the estimated position Pₑₛₜ of the air traffic element 12 by a linear extrapolation or by a polynomial extrapolation from the measured position Pₘₑₛ and complementary measured navigation information Inavₘₑₛ of the air traffic element 12.

FIG. 2 illustrates, by way of example, two estimated positions Pₑₛₜ calculated by linear extrapolation (top right and left of FIG. 2) and an estimated position Pₑₛₜ calculated by polynomial extrapolation (bottom of FIG. 2). The regressions on which the extrapolations are based are shown in dotted lines in FIG. 2.

The calculation module 16 is configured, for example, in the case of a calculation by linear extrapolation, and in the variant where the complementary measured navigation information Inavₘₑₛ is a complementary measured position Pₘₑₛ, to calculate a position P_{estA}(t) of an aircraft A at a time instant t as a function of two measured positions P_{mesA}(t₁) and, P_{mesA}(t₂) with t₂>t₁ and their associated time instants, the position P_{mesA}(t₁) corresponding to the least recent position considered for the extrapolation and the position P_{mesA}(t₂) corresponding to the most recent position considered for the extrapolation. Each coordinate C of the position P_{A}(t) is typically extrapolated as follows, where C corresponds, for example, to a latitude, a longitude or an altitude:

$$C ( {P}_{estA} ( t ) ) = C ( {P}_{mesA} ( {t}_{1} ) ) + \frac{C ( {P}_{mesA} ( {t}_{2} ) ) - C ( {P}_{mesA} ( {t}_{1} ) )}{{t}_{2} - {t}_{1}} . ( t - {t}_{1} ) \qquad ( 1 )$$

The calculation module 16 is also advantageously configured to calculate the estimated position Pₑₛₜ of the air traffic element 12 as a function of a predefined latency period L. The predefined latency period L corresponds to a period between the acquisition of the measured position Pₘₑₛ of an air traffic element 12 and the generation of position data corresponding to said measured position Pₘₑₛ. The predefined latency period L corresponds, for example, to the average duration between the time instant when the measured position Pₘₑₛ of an air traffic element 12 is acquired and the time instant when the position data corresponding to the acquired position are generated. As a variant, the predefined latency period L corresponds to the average duration between the time instant when the measured position Pₘₑₛ is measured by the air traffic element 12 and the time instant when the position data corresponding to the measured position Pₘₑₛ are generated by the generation module 22. The predefined latency period L then corresponds to the sum of the processing times in the air traffic element 12, the transmission time and the processing time in the aircraft 2. The latency time is, for example, a pre-programmed value in the estimation device 10, or else an adjustable value in the estimation device 10.

The calculation module 16 is designed, for example, in the case of a calculation by linear extrapolation, according to the variant where the complementary measured navigation information Inavₘₑₛ is a complementary measured position Pₘₑₛ, and taking into account the predefined duration of latency L, to calculate a position P_{estA}(t) of an aircraft A at a time instant t, as a function of two measured positions P_{mesA}(t₁) and P_{mesA}(t₂) of their associated time instants, and in addition as a function of the predefined latency period L.

Each coordinate C of the position P_{estA}(t) is then typically extrapolated as follows, where C corresponds for example to a latitude, a longitude or an altitude:

$$C ( {P}_{estA} ( t ) ) = C ( {P}_{mesA} ( {t}_{1} ) ) + \frac{C ( {P}_{mesA} ( {t}_{2} ) ) - C ( {P}_{mesA} ( {t}_{1} ) )}{{t}_{2} - {t}_{1}} . ( t - {t}_{1} + L ) \qquad ( 2 )$$

The extrapolation examples described above may, for example, be generalized in the case where the complementary measured navigation information Inavₘₑₛ is a set of N−1 complementary measured positions Pₘₑₛ, where N is greater than or equal to two. The calculation module 16 is then configured to calculate the estimated position Pₑₛₜ of the air traffic element as a function of the measured position Pₘₑₛ and the N−1 complementary measured positions Pₘₑₛ, the regression used for the extrapolation then taking into account N measured positions Pₘₑₛ.

The extrapolation used is, for example, a linear extrapolation according to a first variant, or else a polynomial extrapolation according to a second variant.

Those skilled in the art will, of course, understand that the preceding description is also valid when the predefined latency period L is not taken into account, i.e. when the value taken into account for the period L is zero.

The filtering module 18 is configured to filter the measured position(s) Pₘₑₛ and the complementary measured navigation information Inavₘₑₛ from the air traffic element 12, as a function of their consistency with respect to a previously measured position Pₘₑₛ and to a complementary measured navigation information Inavₘₑₛ. The filtering module 18 is configured to keep only measured positions Pₘₑₛ and validated complementary measured navigation information Inavₘₑₛ having a consistency level greater than a predefined consistency level threshold.

According to a particular variant, the filtering module 18 is configured to filter the positions acquired by the acquisition module 14 before their storage in the storage unit of the acquisition module 14. The calculation module 16 is then configured to calculate the estimated position Pₑₛₜ of the air traffic element 12 as a function of a measured position Pₘₑₛ, filtered by the filtering module 18, then stored in the storage unit, and of respective complementary measured navigation information Inavₘₑₛ, filtered by the filtering module 18, then stored in the storage unit.

The filtering module 18 is, for example, configured to assign a level of consistency for each of the measured values acquired by the acquisition module 14. The level of consistency is, for example, configured to evaluate the consistency of a measured position Pₘₑₛ with respect to a previously measured position Pₘₑₛ, and complementary previously measured navigation information Inavₘₑₛ. The level of consistency is, for example, suitable for evaluating the consistency of complementary measured navigation information Inavₘₑₛ with respect to a previously measured position Pₘₑₛ and to consistency previously measured navigation information Inavₘₑₛ.

In a particular variant, the level of consistency of a measured position Pₘₑₛ at an instant t2, denoted Pₘₑₛ(t2), is calculated as a function of the measured position Pₘₑₛ(t2) at the instant t2 and of a previously measured position Pₘₑₛ at an instant t1 preceding the instant t2, denoted Pₘₑₛ(t1). The level of consistency is advantageously dependent on complementary information transmitted by the ADS-B system to the acquisition module 14, the complementary information comprising, for example, the category or the type of aircraft of the air traffic element 12.

The level of consistency of the measured position Pₘₑₛ(t2) at the instant t2 is, for example, dependent on the variation in speed necessary to go from the previously measured position Pₘₑₛ(t1) to the measured position Pₘₑₛ(t2). The predefined consistency level threshold corresponds, for example, to a limit speed variation of which the traffic element 12 is capable. By way of example, a position Pₘₑₛ(t2) implying a sudden variation in speed, from the previously measured position Pₘₑₛ(t1), which the air traffic element 12 is not capable of, corresponds to a consistency level below the predefined consistency level threshold.

As a variant, the level of consistency of the measured position Pₘₑₛ(t2) at the instant t2 depends on a speed necessary to pass from the previously measured position Pₘₑₛ(t1), at the instant t1 preceding the instant t2, to the measured position Pₘₑₛ(t2). The predefined consistency level threshold corresponds, for example, to a maximum speed of the aircraft or to a relative error threshold between the speed necessary to go from the previously measured position Pₘₑₛ(t1) to the measured position Pₘₑₛ(t2) and the mean of speeds Vₘₑₛ(t1), Vₘₑₛ(t2) measured at the time instants of measurement of the measured positions P Pₘₑₛ(t1), Pₘₑₛ(t2).

In a particular variant, the level of consistency of the complementary measured navigation information Inavₘₑₛ(t2) at an instant t2 is calculated as a function of the complementary navigation information Inavₘₑₛ(t2) measured at the instant t2, and a previously measured complementary navigation information Inavₘₑₛ(t1) at an instant t1 preceding the instant t2. The level of consistency advantageously depends on complementary information transmitted by the ADS-B system to the acquisition module 14, the complementary information comprising, for example, the category or type of aircraft of the air traffic element 12.

In the variant according to which the complementary measured navigation information Inavₘₑₛ is a measured speed Vₘₑₛ, the predefined level of consistency threshold of the complementary navigation information Inavₘₑₛ(t2) measured at the instant t2 corresponds, for example, to the variation of a maximum possible acceleration of which the traffic element 12 is capable of passing from a previously measured speed Vₘₑₛ(t1), at the instant t1, to a measured speed Vₘₑₛ(t2) at the instant t2.

The evaluation module 20 is, for example, configured to calculate the confidence index as a function of a time D elapsed between a temporal instant of acquisition of the measured position Pₘₑₛ and/or of the complementary measured navigation information Inavₘₑₛ and a time instant for calculating the estimated position Pₑₛₜ. The duration D is preferably equal to the time elapsed between the temporal instant of acquisition of the measured position Pₘₑₛ and the temporal instant of calculation of the estimated position Pₑₛₜ. In particular, the longer the duration D, the more likely the air traffic element 12 is to have deviated from its estimated position Pₑₛₜ, and the lower the confidence index.

The evaluation module 20 is typically configured to calculate a confidence index equal to one of three predefined values, such as high, average or low.

The evaluation module 20 is, for example, configured to calculate a high confidence index if the duration D is less than 10 seconds. The evaluation module 20, is for example, configured to calculate an average confidence index if the duration D is between 10 and 20 seconds. The evaluation module 20 is, for example, configured to calculate a low confidence index if the duration D is greater than 20 seconds.

As a variant, the evaluation module 20 is configured to calculate a confidence index as a function of the distance between the air traffic element 12 and the aircraft 2. The evaluation module 20 is, for example, configured to calculate the confidence index according to the probability of the presence of the air traffic element 12 being in a cone whose axis of symmetry passes through the aircraft 2 and the estimated position Pₑₛₜ of the air traffic element 12, the index of confidence being high when the probability of presence in said cone is high, and low when the probability of presence in said cone is low. The angle of such a cone is, for example, 1°, and the confidence index is, for example, high when the probability of the presence of the traffic element 12 in such a cone is greater than 90%; average when the probability of the presence of the traffic element 12 in such a cone is between 70% and 90%; and low when the probability of presence in such a cone is less than 70%. The generation module 22 is configured to generate position data dependent on the estimated position Pₑₛₜ of the air traffic element 12.

The generation module 22 is further preferably configured to generate the position data based on the confidence index. The position data includes, for example, at least one symbol 54 associated with a position in space or in a plane. The symbol 54 generated by the generation module 22 is typically different depending on the confidence index.

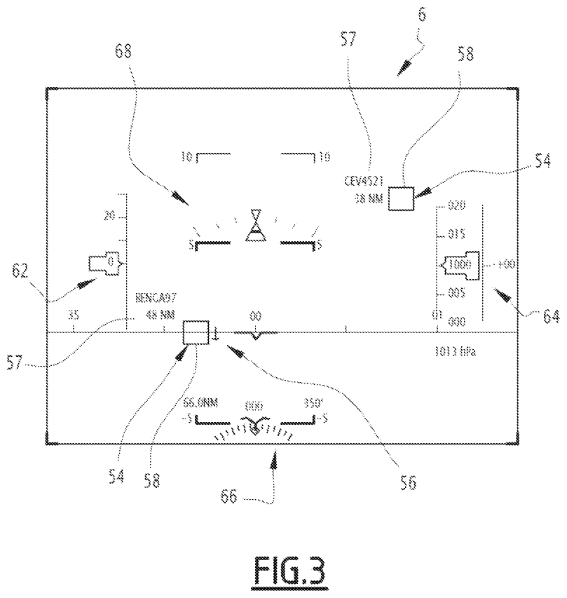

The position data that the generation module 22 is configured to generate preferably comprises a symbol 54 associated with a position in space or in a plane, and, further, a first complementary symbol 56 indicating whether the air traffic element 12 is ascending or ascending, as illustrated in FIG. 3, the first complementary symbol 56 being, for example, an arrow, oriented upwards if the air traffic element 12 is ascending or else downwards if it is descending; the absence of an arrow corresponds to a flight at a substantially constant altitude.

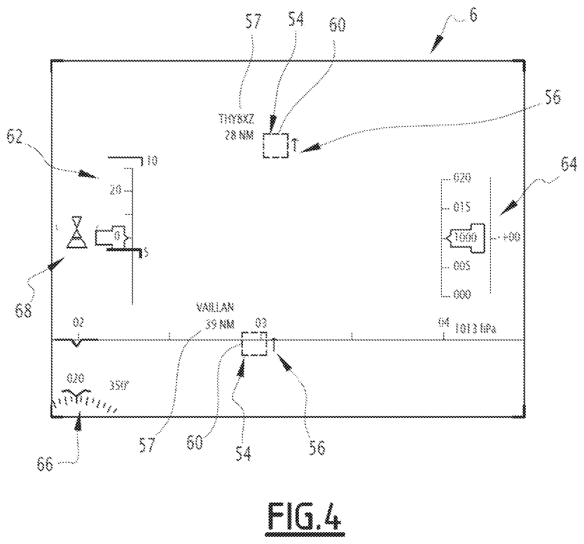

The position data that the generation module 22 is configured to generate, preferably further comprises a second complementary symbol 57 indicating, for example, an identifier of the air traffic element 12, as well as its distance from the aircraft 2, as shown in FIGS. 3 and 4.

As illustrated in FIG. 3, the generation module 22 is, for example, configured to generate a rectangular symbol in solid line 58 at the estimated position Pₑₛₜ of the air traffic element 12 when the confidence index is high, this symbol being suitable. to be displayed on the display screen 6.

As illustrated in FIG. 4, the generation module 22 is, for example, configured to generate a rectangular symbol in dotted lines 60 at the estimated position Pₑₛₜ of the air traffic element 12 when the confidence index is average, this symbol being suitable to be displayed by the display screen 6.

The generation module 22 is, for example, configured to generate no symbol when the confidence index is low.

FIGS. 3 and 4 illustrate other elements capable of being displayed, for example, on the display screen 6, at the same time as the position data of the air traffic element, such as the symbol 54, the first complementary symbol 56 and the second complementary symbol 57. The other elements able to be displayed on the display screen 6 are the primary piloting parameters comprising, for example, a speed indicator 62, an altimeter 64, a compass 66 and an attitude indicator 68.

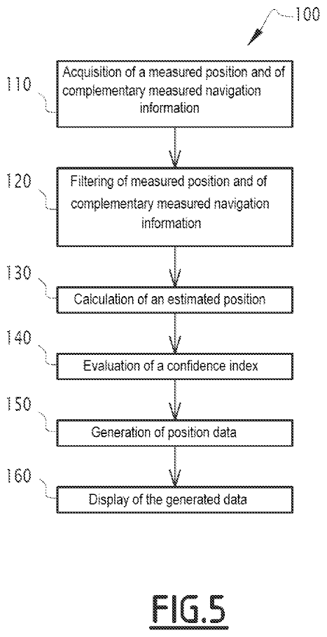

The method 100 of estimating the position of an air traffic element 12 is illustrated in FIG. 5.

During the acquisition step 110 of the method 100, the acquisition module 14 acquires a measured position Pₘₑₛ and complementary measured navigation information Inavₘₑₛ of the air traffic element 12. The measured position Pₘₑₛ and the complementary measured navigation information Inavₘₑₛ are, for example, measured by the air traffic element 12 and transmitted to the aircraft 2, for example using an ADS-B navigation system. where they are acquired by the acquisition module 14.

The acquisition step 110 is optionally followed by a filtering step 120 of the method 100. During the optional filtering step 120, the filtering module 18 filters the measured positions Pₘₑₛ while the complementary measured navigation information Inavₘₑₛ of the air traffic element 12 according to its consistency. The filtering module 18 keeps only measured positions Pₘₑₛ and validated complementary measured navigation information Inavₘₑₛ having a level of consistency greater than a predefined threshold.

During the filtering step 120, or alternatively during a storage step not shown, the measured position Pₘₑₛ and/or the complementary measured navigation information Inavₘₑₛ are stored in the storage unit. In particular, when the filtering precedes the storage of the measured positions Pₘₑₛ and the complementary measured navigation information Inavₘₑₛ, only the measured positions Pₘₑₛ and the validated complementary measured navigation information Inavₘₑₛ having a level of consistency greater than a predefined threshold are stored in the storage unit.

Following the optional filtering step 120, the calculation module 16 calculates an estimated position Pₑₛₜ of the air traffic element 12 during a calculation step 130 of the method 100. As a variant, the calculation module 16 calculates an estimated position Pₑₛₜ of the air traffic element 12 during the calculation step 130 directly following the acquisition step 110 or the storage step.

During the calculation step 130, the calculation module 16 calculates the estimated position Pₑₛₜ of the air traffic element 12 as a function of a measured position Pₘₑₛ and of complementary measured navigation information Inavₘₑₛ of the air traffic element 12. Optionally, the calculation module 16 calculates the estimated position Pₑₛₜ of the air traffic element 12 as a function of a measured position Pₘₑₛ and of validated complementary measured navigation information Inavₘₑₛ during the filtering step 120 and/or stored in the storage unit during the storage step.

During the calculation step 130, the calculation module 16 preferably calculates the estimated position Pₑₛₜ of the air traffic element 12 by an extrapolation from the measured position Pₘₑₛ and the complementary measured navigation information Inavₘₑₛ from the air traffic element 12. The extrapolation performed by the calculation module 16 is typically a linear or polynomial extrapolation.

During the calculation step 130, the calculation module 16 further calculates, for example, the estimated position Pₑₛₜ as a function of the predefined latency period L.

The calculation step 130 is optionally followed by an evaluation step 140 of the method 100.

During the evaluation step 140, the evaluation module 20 evaluates the confidence index for the estimated position Pₑₛₜ of the air traffic element 12. The confidence index is evaluated as a function of the elapsed time D. between a temporal instant of acquisition of a measured position Pₘₑₛ and of the complementary measured navigation information Inavₘₑₛ during the acquisition step and the temporal instant of calculation of the estimated position Pₑₛₜ during the calculation step 130.

The confidence index is, for example, high if the time difference is less than 10 seconds, average if the time difference is between 10 and 20 seconds, and low if the time difference is greater than 20 seconds.

The evaluation step 140 is optionally followed by a generation step 150 of the method 100.

During the generation step 150, the generation module 22 generates position data suitable for being displayed on the display screen 6. The position data generated depend on the estimated position Pₑₛₜ during the calculation step 130. In particular, the generated position data comprise at least one symbol 54 intended to be displayed on the display screen in a position defined by all of the estimated coordinates Pₑₛₜ during the calculation step 130. The data positions generated during the generation step 150 are, in particular, suitable for being displayed on a transparent head-up screen or on a screen presenting a synthetic view of the terrain in 3D.

The position data generated during the generation step 150 preferably further depends on the confidence index calculated during the evaluation step 140. During the generation step 150, the generation module 22 generates, for example, symbols 54 associated with a position corresponding to the estimated position Pₑₛₜ, forming the generated position data. The symbol 54 is, for example, a rectangle in solid line if the confidence index is high, and a rectangle in dotted lines if the confidence index is average. The generation module 22 does not generate, for example, position data if the confidence index is low, or alternatively generates position data that does not include a symbol.

Following the generation step 150, the generated position data is displayed during an optional display step 160 of the method 100 by the display module 8 on the display screen 6, as shown, for example, in FIGS. 3 and 4.

The electronic device 10 for estimating the position(s) of air traffic element(s) 12, with the calculation of the position of the air traffic element 12 as a function of the measured position Pₘₑₛ and of the complementary measured navigation information Inavₘₑₛ of said air traffic element 12 is particularly advantageous since it makes it possible to limit a jerky display of the estimated position Pₑₛₜ by reducing inconsistencies between the actual position of the air traffic element 12 and the estimated position Pₑₛₜ of the air traffic element 12 which is essential for a compliant display on a transparent head-up display, whether worn on the pilot's head (Head Worn Display) or fixed on the aircraft (Head Up Display), thus allowing a perfect superposition of the position data with the air traffic element 12 seen by the pilot through the transparent screen. The invention thus facilitates, in particular, the direct visual acquisition by the pilot of the aircraft 2 of an air traffic element 12, thereby reducing his workload while increasing his awareness of the external environment.

The calculation of the estimated position Pₑₛₜ via a linear or polynomial extrapolation allows a simple and precise determination of each estimated position Pₑₛₜ as a function of the measured position Pₘₑₛ and the complementary measured navigation information Inavₘₑₛ.

The evaluation module 20 also makes it possible to simplify the classification of the estimated positions Pₑₛₜ according to the confidence index evaluated for each estimated position Pₑₛₜ.

The calculation of the estimated position Pₑₛₜ of the air traffic element 12 as a function of the predefined latency period L is particularly advantageous since it makes it possible to compensate for the typical delay between the acquisition of the measured position Pₘₑₛ and the complementary measured navigation information Inavₘₑₛ and the generation of corresponding position data. This makes it possible to further reduce the difference between the estimated position Pₑₛₜ intended to be displayed and the actual position of the air traffic element 12.

The filtering module 18 advantageously makes it possible to eliminate outlier measured position values Pₘₑₛ, and improves the accuracy of the estimation of the estimated position Pₑₛₜ.

It may thus be seen that the estimation device 10, the display system 4 and the estimation method 100 according to the invention make it possible to obtain an estimated position Pₑₛₜ the evolution of which is more continuous and thus minimize the inconsistencies between the actual position of the air traffic element 12 and its estimated position Pₑₛₜ.

1. Electronic estimation device for estimating a position of an air traffic element, the device being intended to be carried on board an aircraft, and comprising:
an acquisition module configured to acquire a measured position of the air traffic element and complementary measured navigation information of the air traffic element; and
a calculation module configured to calculate an estimated position of the air traffic element,
wherein the calculation module is configured to calculate the estimated position of the air traffic element as a function of the measured position and of the complementary measured navigation information acquired for the air traffic element,
the device further comprising a generation module configured to generate position data suitable for being displayed on a display screen, said data depending on the estimated position of the element air traffic,
the calculation module being configured to calculate the estimated position of the air traffic element as a function further of a predefined period of latency between the acquisition of the measured position of an air traffic element and generating position data corresponding to said measured position.

2. Device according to claim 1, wherein the complementary measured navigation information for the air traffic element is chosen from the group consisting of: a measured position of the complementary air traffic element, a set of at least two measured positions of the complementary air traffic element and one measured speed of the air traffic element.

3. Device according to claim 1, wherein the calculation module is configured to calculate the estimated position of the air traffic element by extrapolation from the measured position and complementary measured navigation information of the air traffic element,

4. Device according to claim 3, wherein the extrapolation is a linear or polynomial extrapolation.

5. Device according to claim 1, wherein the device further comprises an evaluation module configured to evaluate a confidence index for the estimated position of the air traffic element,

6. Device according to claim 5, wherein the calculation of the confidence index is a function of a time elapsed between a temporal instant of acquisition of the measured position and of the complementary measured navigation information, and a temporal instant of calculation of the estimated position.

7. Device according to claim 1, wherein the display screen is a transparent display screen.

8. Device according to claim 5, wherein the generation module is configured to generate said position data further based on the confidence index.

9. Device according to claim 1, wherein the device further comprises a filtering module configured to filter the measured position(s) and the complementary measured navigation information of the air traffic element as a function of their consistency with respect to a previously measured position and to previously measured complementary navigation information, and to keep only measured positions and complementary measured navigation information validated having a level of consistency greater than a predefined threshold, the calculation module then being configured to calculate the estimated position of the air traffic element based on a measured position and complementary measured navigation information validated.

10. Electronic system for displaying the position data of air traffic element(s), intended to be carried on board an aircraft, and comprising:
a display screen;
a display module connected to the display screen;
an electronic device for estimating a position of an air traffic element, the estimating device being connected to the display module,
wherein the electronic estimation device is according to claim 1, the display module being configured to display on the display screen the position data.

11. Method for estimating a position of an air traffic element, the method being implemented by an electronic estimation device intended to be carried on board an aircraft, and comprising the following steps:
acquisition of a measured position of the air traffic element and of complementary measured navigation information of the air traffic element; and
calculation of an estimated position of the respective air traffic element,
wherein the estimated position of the air traffic element is calculated as a function of the measured position and the complementary measured navigation information acquired for the traffic element,
the method comprising a step of generating position data suitable for being displayed on a display screen, said data depending on the estimated position of the air traffic element, and
the estimated position of the air traffic element is calculated in addition to a predefined period of latency between the acquisition of the measured position of an air traffic element and generating position data corresponding to said measured position.

12. Method according to claim 11, wherein the complementary measured navigation information for the air traffic element is chosen from the group consisting of: a measured position of the complementary air traffic element, a set of at least two measured positions of the complementary air traffic element and one measured speed of the air traffic element.

13. A non-transitory computer-readable medium including a computer program comprising software instructions which, when executed by a computer, implement a method according to claim 11.
